(19) United States
(12) Patent Application Publication
(10) Pub. No.: US 2009/0154594 A1
(43) Pub. Date: Jun. 18, 2009

(54) POWER LINE COMMUNICATION DEVICE WITH DC POWER OUTPUT AND NETWORK SIGNAL TRANSMISSION ABILITIES

(75) Inventors: Shiann-Chang Yeh, Taipei Hsien (TW); Tzu-Hsiu Hsiao, Taipei Hsien (TW); Chien-Hong Lin, Taipei Hsien (TW)

Correspondence Address: BURR & BROWN, PO BOX 7068, SYRACUSE, NY, 13261-7068, US

(73) Assignee: ACBEL POLYTECH INC., Taipei Hsien (TW)

(21) Appl. No.: 12/245,141

(22) Filed: Oct. 3, 2008

(30) Foreign Application Priority Data
Dec. 13, 2007 (TW) 096147606

(51) Int. Cl. H04L 27/00

(52) U.S. Cl. 375/295; 340/310.11

(57) ABSTRACT

A power line communication device having DC power output and network signal transmission abilities has a casing, a power cable connector, a network signal converting circuit and a first connecting interface. The network signal converting circuit is connected to the power cable connector, sends and receives network signals over a power cable connected to the power cable connector and transforms an AC power source to a DC power source. The first connecting interface is connected to the network signal converting circuit for connecting to and exchanging the network signals with an external network device and has a network port and a DC power output port. The DC power output port outputs the DC power source from the network signal converting circuit to the external network device. Therefore, the first connecting interface is capable of outputting the DC power source and transmitting the network signals.

### BACKGROUND OF THE INVENTION

1. Field of the Invention

The present invention relates to a power line communication (PLC) device, and more particularly to a PLC device with DC power output and network signal transmission abilities.

2. Description of Related Art

The popularization of Internet technology has resulted in remotely controlled monitoring systems. Each monitoring system comprises a control device and a monitoring device. The monitoring device connects to the utility power system through a power cable to obtain AC power, and also electronically connects to the Internet through a network cable. The control device can electronically connect to and control the monitoring device via the Internet. However, arranging the power cable and the network cable complicates the installation of the monitoring device.

To solve the foregoing shortcoming, a conventional power line communication (PLC) device is invented. The PLC device electrically connects to the utility power system and the Internet with the same one power cable and provides a network cable to connect an active electronic device having a network adapter. When the active electronic device sends data to a recipient, the active electronic device transmits network signals to the PLC device over the network cable. The PLC device processes and couples the network signals from the active electronic device into the power cable and transmits the coupled network signals to the recipient over the utility power system. The active electronic device also receives network signals sent from the recipient over the PLC device.

Therefore, the PLC device provides the same network function with digital subscriber line (XDSL) modems, such as asymmetric digital subscriber line (ADSL) modem or cable modems, without using telephone wires or coaxial cables to connect to the Internet. Consequently, the monitoring device such as a network camera used to remotely monitor and view images is able to electronically connect to the Internet over the PLC device.

With reference to FIG. 9, the network camera (60) comprises an image capturing and processing unit (61), a media access control (MAC) chip (62) with media independent interface (MII), a physical layer circuit (63), a registered jack (RJ) 45 port and a power converter (70). Digital image data output from the image capturing and processing unit (61) are transformed to network signals by the MAC chip (62) and the physical layer circuit (63). The network signals are sent to the PLC device (50) over a RJ45 cable. The power converter (70) converts an outer AC power source into a DC power source to provide operating power to the network camera (60).

The PLC device (50) comprises a RJ45 port, a physical layer circuit (54), a communication chip (52) having a MAC processing unit (521), an analog front end (AFE) unit (53), a signal coupling unit (51) and an AC to DC circuit (55). The PLC device (50) is connected to the network camera (60) over the RJ45 cable and receives and sends the network signals sent from the network camera (60) to the communication chip (52) over the physical layer circuit (54). The communication chip (52) re-transforms the network signals into digital data and couples the digital data into the power cable over the AFE unit (53) and the signal coupling unit (51). The AC to DC circuit (55) is connected to and converts an outer AC power source into a DC power source to provide operating power to the PLC device (50).

However, the network camera (60) still requires a RJ45 cable connecting to the PLC device (50) so the arrangement of the power cable and the RJ45 cable still complicates the installation of the network camera (60).

To overcome the shortcomings, the present invention provides a PLC device with DC power output and network signal transmission abilities to mitigate or obviate the aforementioned problems.

### SUMMARY OF THE INVENTION

The main objective of the invention is to provide a power line communication (PLC) device with DC power output and network signal transmission abilities.

The PLC device in accordance with the present invention comprises a casing, a power cable connector, a network signal converting circuit and first connecting interface. The network signal converting circuit is connected to the power cable connector, sends and receives network signals over a power cable connected to the power cable connector and transforms an AC power source to a DC power source. The first connecting interface is connected to the network signal converting circuit, is for connecting to and exchanging the network signals with an external network device and has a network port and a DC power output port. The DC power output port outputs the DC power source from the network signal converting circuit to the external network device. Therefore, the first connecting interface is capable of outputting the DC power source and transmitting the network signals.

The other objective of the invention is to provide a PLC device that has engaging elements to easily mounting the external network device on the PLC device. Furthermore, the first connecting interface may be a plug or a socket connecting to a second connecting interface that may be a socket or a plug.

Other objectives, advantages and novel features of the invention will become more apparent from the following detailed description when taken in conjunction with the accompanying drawings.

### BRIEF DESCRIPTION OF THE DRAWINGS

FIG. 1 is a top perspective view of a first embodiment of a power line communication (PLC) device in accordance with the present invention and a network camera;

FIG. 2 is a functional block diagram of the PLC device connecting to the network camera in FIG. 1;

FIG. 3 is a top perspective view of a second embodiment of a PLC device in accordance with the present invention;

FIG. 4 is a top perspective view of the PLC device and the network camera in FIG. 1 connecting together;

FIG. 5 is a bottom perspective view of the PLC device and the network camera in FIG. 1;

FIG. 6 is a partially sectional side view of the PLC device and the network camera in FIG. 4;

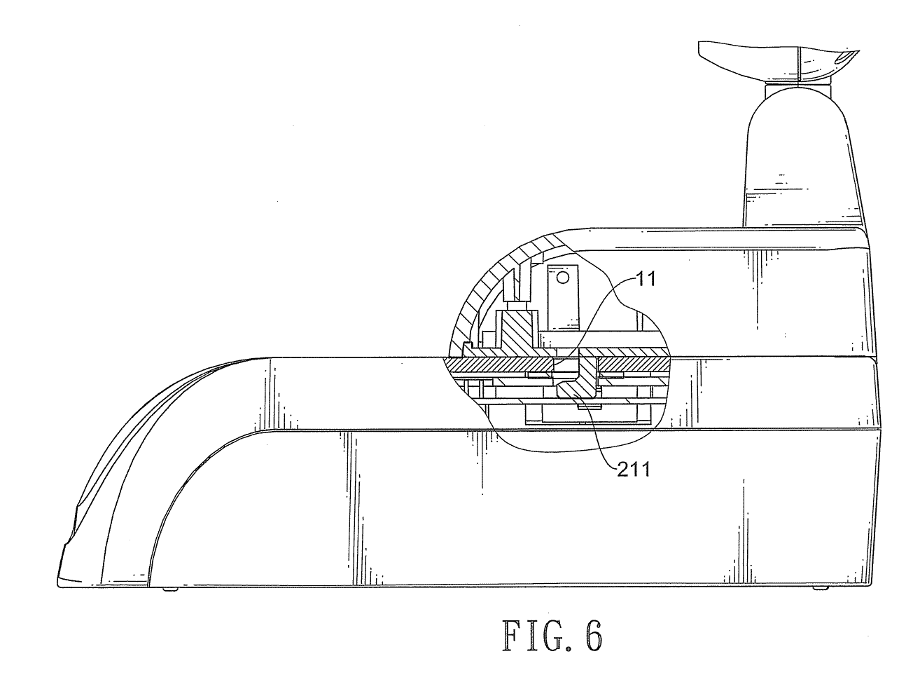

FIG. 7 is a top perspective view of a first embodiment of a PLC device and an adapter;

FIG. 8 is a functional block diagram of the PLC device connecting to the adapter in FIG. 7; and

FIG. 9 is a functional block diagram of a conventional PLC device connecting to a conventional network camera.

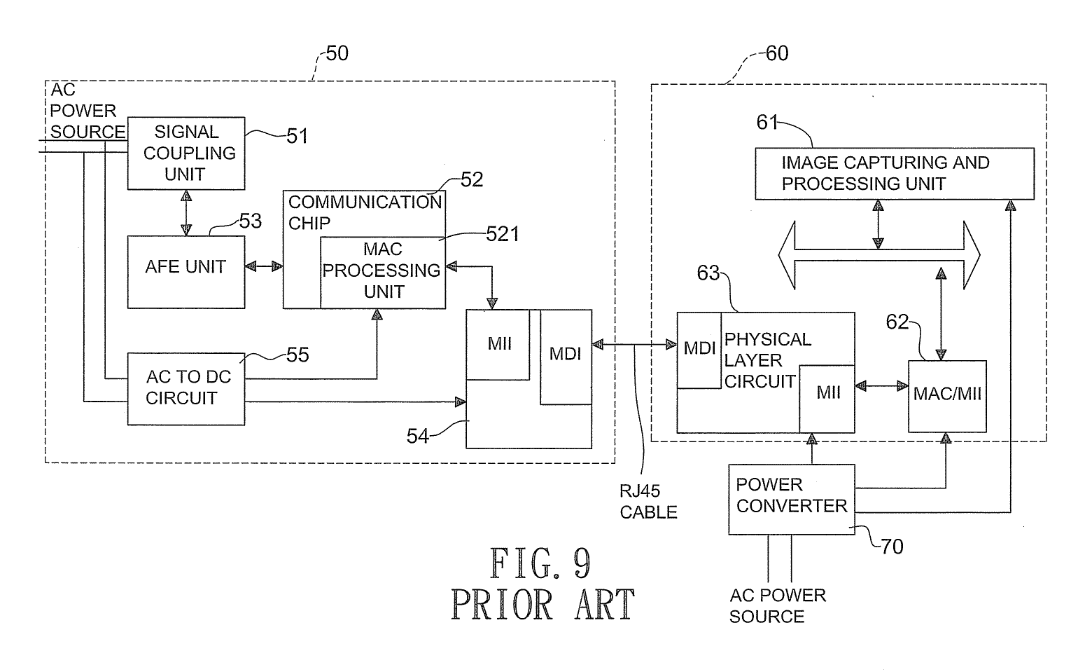

### DETAILED DESCRIPTION OF PREFERRED EMBODIMENT

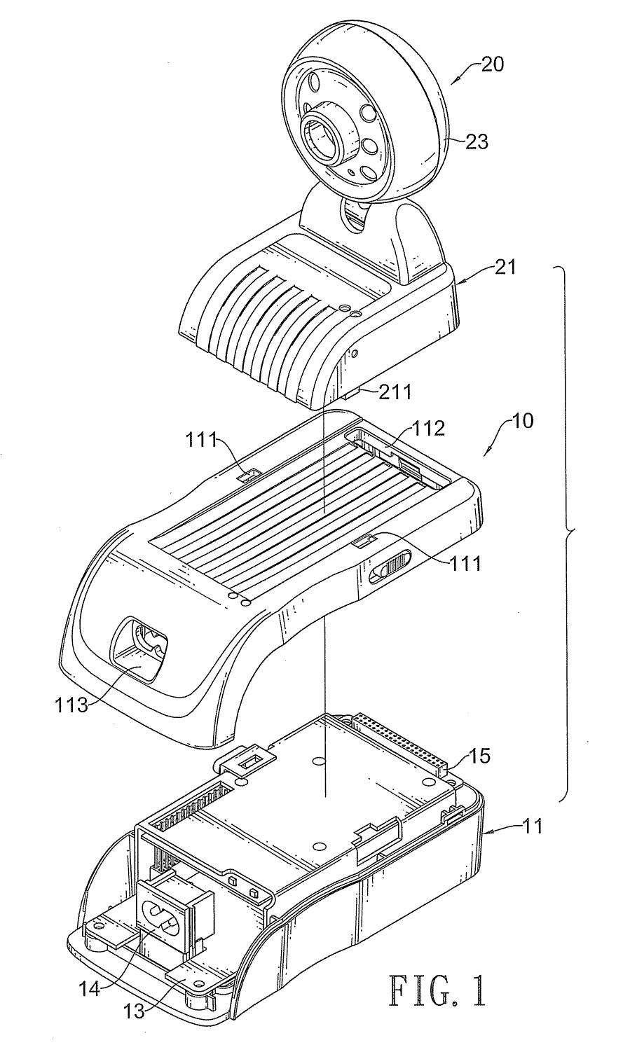

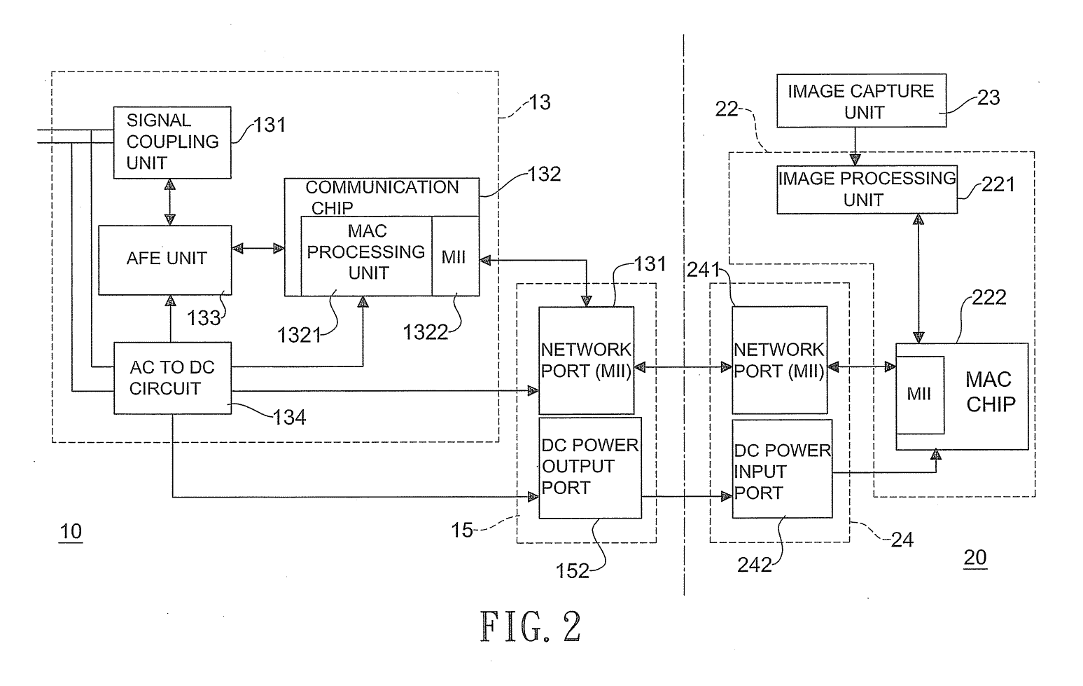

With reference to FIGS. 1 and 2, a power line communication (PLC) device (10) in accordance with the present invention comprises a casing (11), a power cable connector (14), a network signal converting circuit (13) and a first connecting interface (15).

The casing (11) may have a top, a front, two optional notches (111), an optional through slot (112) and an optional opening (113). The notches (111) and the through slot (112) are formed on the top of the casing (11). The opening (113) is formed on the front of the casing (11).

The power cable connector (14) is mounted in the casing (11), exposes through the opening (113) of the casing (11) and is for connecting to a power cable that connects to an AC power source.

The network signal converting circuit (13) is mounted in the casing (11) and is connected to the power cable connector (14). The network signal converting circuit (13) sends and receives network signals over the power cable to access the Internet and transforms the AC power source into a DC power source. The network signal converting circuit (13) may further comprise a signal coupling unit (131), a communication chip (132) and an AC to DC circuit (134).

The signal coupling unit (131) is connected to the power cable connector (14) to decouple network signals from the AC power source and couple network signals into the AC power source.

The communication chip (132) is connected to the signal coupling unit (131) over an analog front end (AFE) unit (133) and has a media access control (MAC) processing unit (1321). Furthermore, the communication chip (132) may be an integrated circuit (IC) manufactured by DS2 company and numbered DSS9010 or DSS9001. The AFE unit (133) may be an IC also manufactured by DS2 company and numbered DSS7700 or DS7800.

The MAC processing unit (1321) may further have a connecting interface such as a media independent interface (MII) (1322).

The AC to DC circuit (134) has an input terminal and multiple output terminals and converts the AC power source to the DC power source. The input terminal of the AC to DC circuit (134) is connected to the power cable connector (14) to obtain the AC power source. Some of the output terminals of the AC to DC circuit (134) are connected respectively to the communication chip (132) and the AFE unit (133).

The first connecting interface (15) is mounted on the casing (11), may expose through the through slot (112), connect to the network signal converting circuit (13) and is for connecting to and exchanging the network signals with an external network device. The first connecting interface (15) comprises a network port (151) and a DC power output port (152).

The network port (151) is connected to the MAC processing unit (1321) of the communication chip (132) and may be a MII, attachment unit interface (AUI), gigabit media independent interface (GMII) or X attachment unit interface (XAUI) network port. Because the MII, AUI, GMII or XAUI is used to connect the MAC processing unit (1321) to a conventional physical layer circuit, the conventional physical layer circuit is not necessary when connecting the MII, AUI, GMII or XAUI network port to the MAC processing unit (1321) having the MII.

The DC power output port (152) is connected to one output terminal of the AC to DC circuit (134) to output the DC power source from the AC to DC circuit (134).

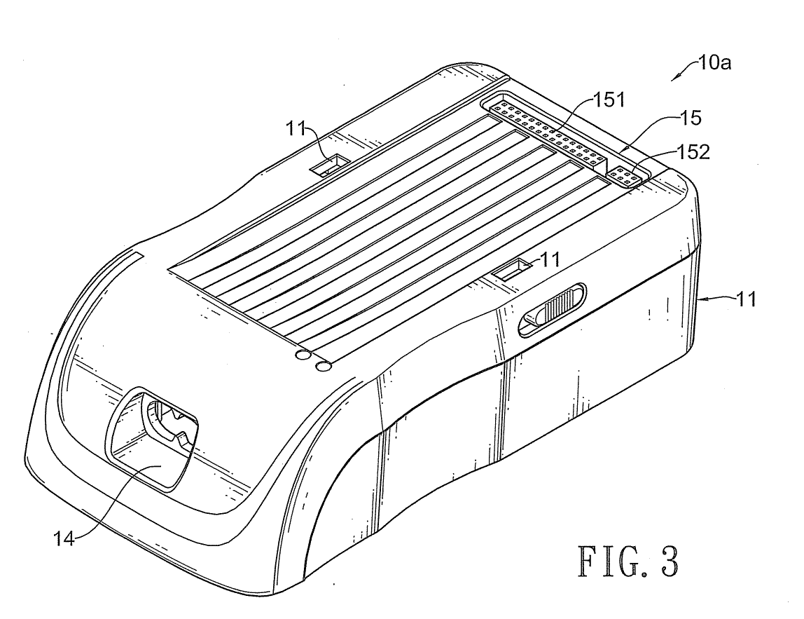

Furthermore, with further reference to FIG. 3, the network port (151) and the DC power output port (152) may be combined to form a single socket or plug or may be two independent sockets or plugs.

Based on the foregoing descriptions, the conventional physical layer circuit is not required for the PLC device (10) of the present invention. Furthermore, the first connecting interface (15) is capable of outputting the DC power source and transmitting the network signals.

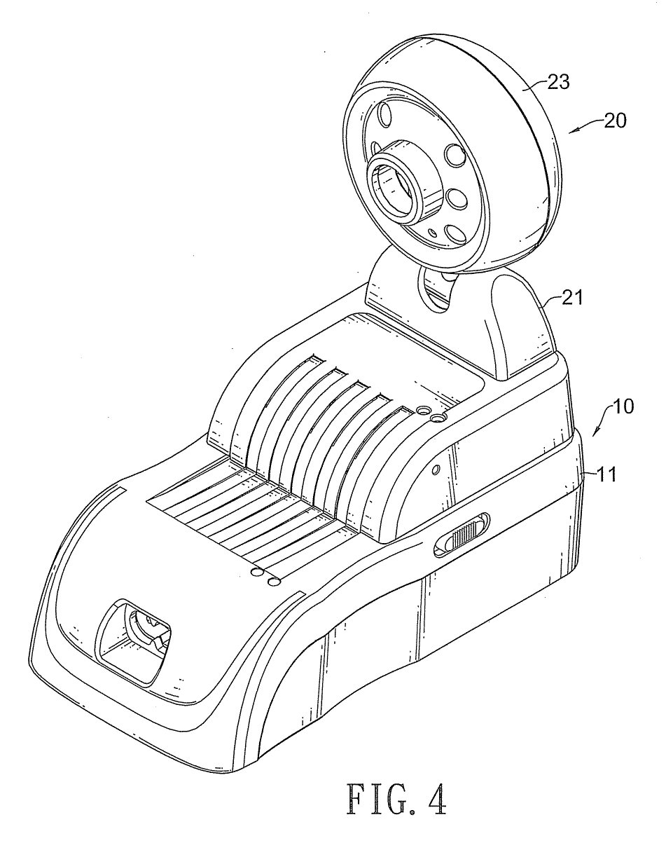

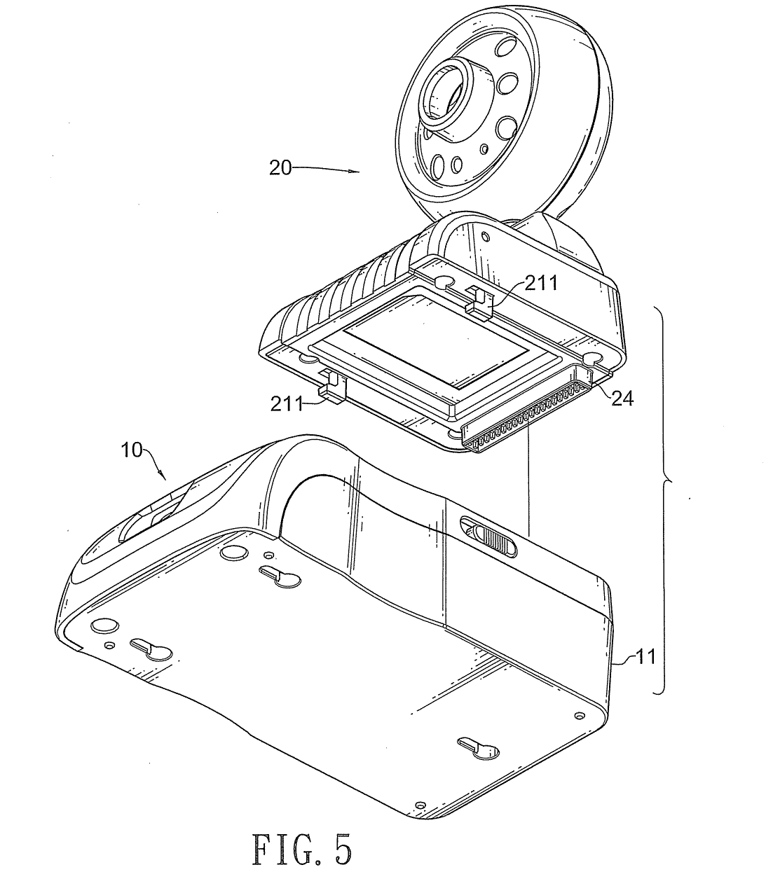

With further reference to FIGS. 4 and 5, the external network device may be a network camera (20) mounted on the casing (10) and connected to the first connecting interface (15) to obtain the DC power source and exchange the network signals with the PLC device (10). The network camera (20) may comprise a base (21), an image capture unit (23), a processing circuit (22) and a second connecting interface (24).

The base (21) has a top and a bottom and may have two engaging elements (211). The engaging elements (211) are formed on the bottom of the base (21) and detachably engaged respectively with the notches (111) on the casing (11) to fix the network camera (20) on the PLC device (10).

The image capture unit (23) is mounted on the top of the base (21) to capture images.

The processing circuit (22) is mounted in the base (21), connects to the image capture unit (23), retrieves the captured images from the image capture unit (23) and transforms the captured images into network signals. The processing circuit (22) may further comprise an image processing unit (221) and a MAC chip (222).

The image processing unit (221) has an input terminal. The input terminal of the image processing unit (221) connects to the image capture unit (23) to retrieve the images captured by the image capture unit (23).

The MAC chip (222) is connected to the image processing unit (221) to transform the retrieved images into network signals.

The second connecting interface (24) is mounted on the bottom of the base (21), is connected to the processing circuit (22) to retrieve the network signals transformed from the captured images and is detachably connected to the first connecting interface (15) to send the network signals to the PLC device (10). Furthermore, the second connecting interface (24) comprises a network port (241) and a DC power input port (242).

The network port (241) of the second connecting interface (24) corresponds to and is detachably connected to the network port (151) of the first connecting interface (15) and may be connected to the MAC chip (222) of the processing circuit (22). Furthermore, the network port (241) of the second connecting interface (24) may be a MII, AUI, GMII or XAUI network port.

The DC power input port (242) of the second connecting interface (24) corresponds to and is detachably connected to the DC power output port (152) of the first connecting interface (15).

Furthermore, the network port (241) and the DC power input port (242) of the second connecting interface (24) may be combined to form a single plug or socket corresponding to the network port (151) and the DC power port (152) of the first connecting interface (15) forming a single socket or plug. Additionally, the network port (241) and the DC power input port (242) of the second connecting interface (24) may be two independent plugs or sockets corresponding respectively to the network port (151) and the DC power port (152) of the first connecting interface (15) forming two independent plugs or sockets.

Based on the foregoing descriptions, the network camera (20) obtains the DC power source from the PLC device (10). Furthermore, when the network camera (20) captures images, the network camera (20) will transform the captured images into network signals and send the network signals to the PLC device (10) over the second connecting interface (24) and the first connecting interface (15). The signal coupling unit (131) of the network signal converting circuit (13) in the PLC device (10) receives the network signals from the network camera (20) and couples the network signals into the AC power source. Therefore, the network signal converting circuit (13) sends the network signals from the network camera (20) to Internet over the power cable. Consequently, the network camera (20) connects to the PLC device (10) of the present invention to obtain operating power and connect to Internet without a network cable and a power cable.

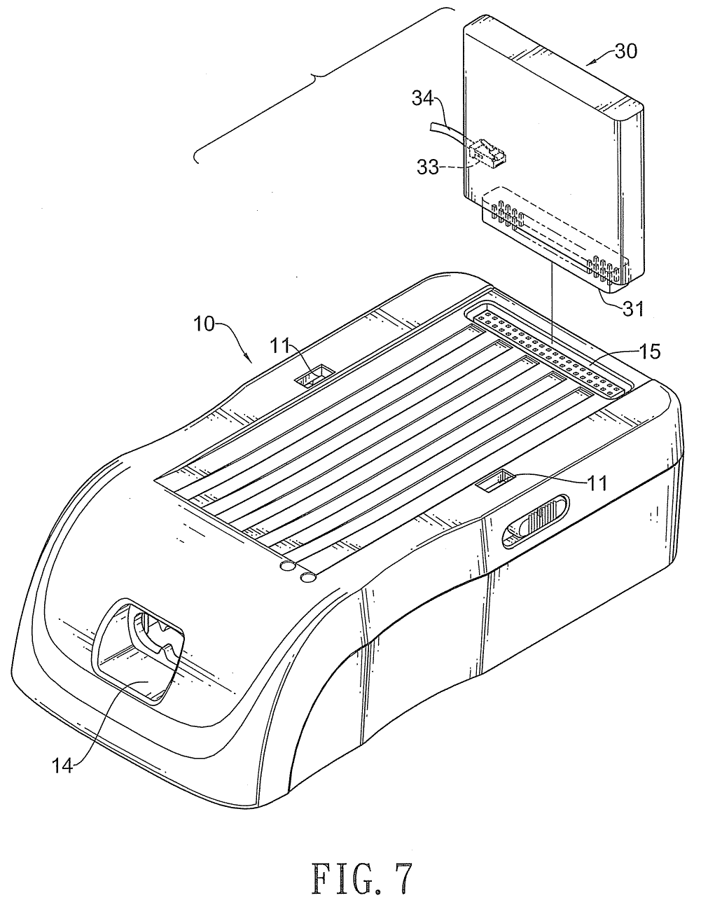

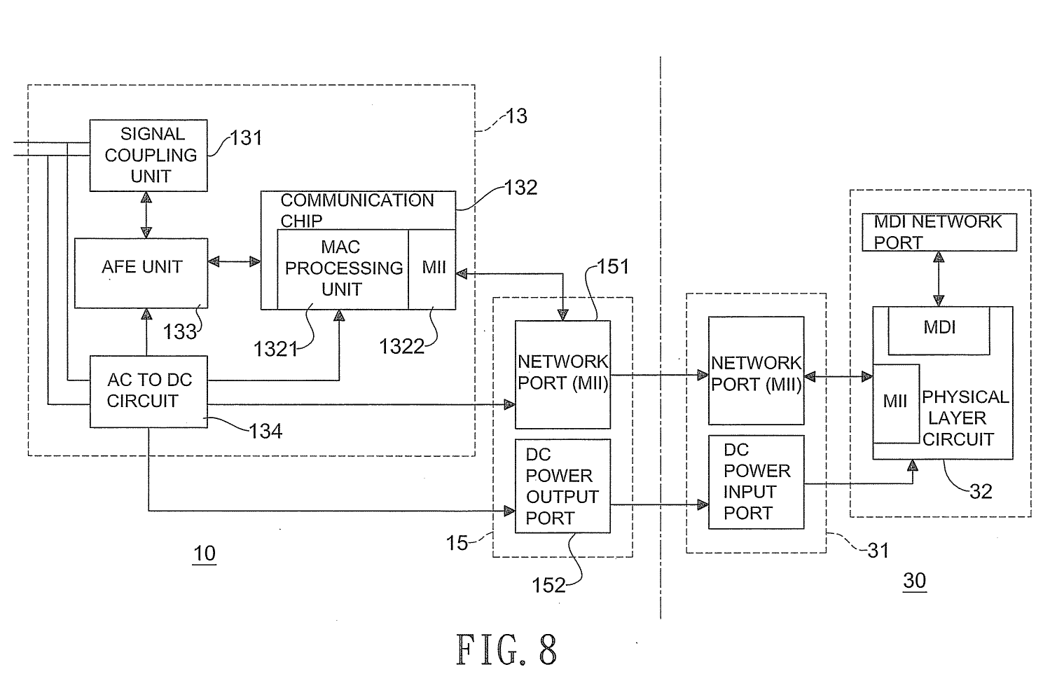

In addition, if the PLC device (10) only connects to an electronic device such as a laptop or a device having a media dependent interface (MDI) network port to the Internet, the external network device may be an adapter. With further reference to FIGS. 7 and 8, the adapter (30) comprises a third connecting interface (31), a physical layer circuit (32) and a MDI network port (33).

The third connecting interface (31) is detachably connected to the first connecting interface (15) on the PLC device (10). Furthermore, the third connecting interface (31) may be a socket or a plug corresponding respectively to the first connecting interface (15) forming a plug or a socket.

The physical layer circuit (32) is connected to the third connecting interface (31), transforms the network signals, such as MII network signals, into physical layer network signals and re-transforms the physical layer network signals.

The MDI network port (33) is connected to the physical layer circuit (32) and is for connecting to a registered jack (RJ) 45 cable (34) connected to the electronic device to exchange the physical layer network signals with the electronic device.

Based on the foregoing descriptions, a desktop or a laptop is able to connect to Internet over the RJ45 cable (34), the adapter (30), the PLC device (10) and the power cable.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power line communication device with DC power output and network signal transmission abilities comprising:
a casing;
a power cable connector mounted in the casing and adapted to connect to a power cable that connects to an AC power source;
a network signal converting circuit mounted in the casing, connected to the power cable connector, sending and receiving network signals over the power cable to access the Internet and transforming the AC power source into a DC power source; and
a first connecting interface mounted on the casing, connecting to the network signal converting circuit, adapted to be connected to an external network device for exchanging the network signals and comprising
a network port connected to the network signal converting circuit; and
a DC power output port connected to the network signal converting circuit to output the DC power source from the network signal converting circuit.

2. The power line communication device as claimed in claim 1, wherein the network signal converting circuit farther comprises:
a signal coupling unit connected to the power cable connector to decouple network signals from the AC power source and couple network signals into the AC power source;
a communication chip connected to the signal coupling unit over an analog front end (AFE) unit and having a media access control (MAC) processing unit connected to the network port of the first connecting interface; and
an AC to DC circuit converting the AC power source to the DC power source and having
an input terminal connected to the power cable connector to obtain the AC power source; and
multiple output terminals connected respectively to the communication chip, the AFE unit and the DC power output port of the first connecting interface.

3. The power line communication device as claimed in claim 1, wherein the network port of the first connecting interface is a media independent interface (MII), attachment unit interface (AUI), gigabit media independent interface (GMII) or X attachment unit interface (XAUI) network port.

4. The power line communication device as claimed in claim 2, wherein the communication chip is an integrated circuit (IC) numbered DSS9010 or DSS9001, and the AFE unit is an IC numbered DSS7700 or DS7800.

5. The power line communication device as claimed in claim 1, wherein the casing further has:
a top;
a front;
a through slot formed on the top of the casing to expose the first connecting interface through the casing; and
an opening formed on the front of the casing to expose the power cable connector through the casing.

6. The power line communication device as claimed in claim 2, wherein the casing further has:
a top;
a front;
a through slot formed on the top of the casing to expose the first connecting interface through the casing; and
an opening formed on the front of the casing to expose the power cable connector through the casing.

7. The power line communication device as claimed in claim 5, wherein the network port and the DC power output port of the first connecting interface are combined to form a single socket.

8. The power line communication device as claimed in claim 6, wherein the network port and the DC power output port of the first connecting interface are combined to form a single socket.

9. The power line communication device as claimed in claim 5, wherein the network port and the DC power output port of the first connecting interface are two independent sockets.

10. The power line communication device as claimed in claim 6, wherein the network port and the DC power output port of the first connecting interface are two independent sockets.

11. A power line communication device with an image capture ability comprising:
a casing;
a power cable connector mounted in the casing and adapted to connect to a power cable that connects to an AC power source;
a network signal converting circuit mounted in the casing, connected to the power cable connector, sending and receiving network signals over the power cable to access the Internet and transforming the AC power source into a DC power source;
a first connecting interface mounted on the casing, connecting to the network signal converting circuit, adapted to connect to an external network device for exchanging the network signals and comprising
a network port connected to the network signal converting circuit; and
a DC power output port connected to the network signal converting circuit to output the DC power source from the network signal converting circuit; and
a network camera mounted on the casing and connected to the first connecting interface to obtain the DC power source and exchange the network signals with the network signal converting circuit.

12. The power line communication device as claimed in claim 11, wherein the network camera further comprises:
a base having a top and a bottom;
an image capture unit mounted on the top of the base to capture images;
a processing circuit mounted in the base, connecting to the image capture unit, retrieving the captured images from the image capture unit and transforming the captured images into network signals; and
a second connecting interface mounted on the bottom of the base, connected to the processing circuit to retrieve the network signals transformed from the captured images, detachably connected to the first connecting interface to send the network signals to the network signal converting circuit and having
a network port corresponding to and detachably connected to the network port of the first connecting interface; and
a DC power input port corresponding to and detachably connected to the DC power output port of the first connecting interface.

13. The power line communication device as claimed in claim 12, wherein:
the network signal converting circuit further comprises
a signal coupling unit connected to the power cable connector to decouple network signals from the AC power source and couple network signals into the AC power source;
a communication chip connected to the signal coupling unit over an AFE unit and having a MAC processing unit connected to the network port of the first connecting interface; and
an AC to DC circuit converting the AC power source into the DC power source and having
an input terminal connected to the power cable connector to obtain the AC power source; and
multiple output terminals connected respectively to the communication chip, the AFE unit and the DC power output port of the first connecting interface; and
the processing circuit in the network camera further comprises
an image processing unit having an input terminal connected to the image capture unit to retrieve the images captured by the image capture unit; and
a MAC chip connected to the network port of the second connecting interface and the image processing unit to transform the retrieved images into network signals.

14. The power line communication device as claimed in claim 12, wherein the network ports of the first and the second connecting interfaces are MII, AUI, GMII or XAUI network ports.

15. The power line communication device as claimed in claim 13, wherein the communication chip is an IC numbered DSS9010 or DSS9001, and the AFE unit is an IC numbered DSS7700 or DS7800.

16. The power line communication device as claimed in claim 11, wherein:
the casing further has
a top;
a front;
a through slot formed on the top of the casing to expose the first connecting interface through the casing;
an opening formed on the front of the casing to expose the power cable connector through the casing; and
at least one notch formed on the top of the casing; and
the base further has at least one engaging element formed on the bottom of the base and detachably engaged respectively with the notches on the casing.

17. The power line communication device as claimed in claim 13, wherein:
the casing further has
a top;
a front;
a through slot formed on the top of the casing to expose the first connecting interface through the casing;
an opening formed on the front of the casing to expose the power cable connector through the casing; and
at least one notch formed on the top of the casing; and
the base further has at least one engaging element formed on the bottom of the base and detachably engaged respectively with the notches on the casing.

18. The power line communication device as claimed in claim 11, wherein the network port and the DC power output port of the first connecting interface are two independent sockets.

19. The power line communication device as claimed in claim 12, wherein:
the network port and the DC power output port of the first connecting interface are combined to form a single socket; and
the network port and the DC power output port of the second connecting interface are combined to form a single plug.

20. The power line communication device as claimed in claim 17, wherein:
the network port and the DC power output port of the first connecting interface are combined to form a single socket; and
the network port and the DC power output port of the second connecting interface are combined to form a single plug.
